(19) United States
(12) Patent Application Publication
(10) Pub. No.: US 2025/0121306 A1
(43) Pub. Date: Apr. 17, 2025

(54) FILTER FOR FLUID SYSTEM HAVING SEAL WITH INTEGRATED DRAIN BACK VALVING

(71) Applicant: Caterpillar Inc., Peoria, IL (US)

(72) Inventors: Stephen E. Oedewaldt, Mapleton, IL (US); Jon T. Immel, Chillicothe, IL (US)

(73) Assignee: Caterpillar Inc., Peoria, IL (US)

(21) Appl. No.: 18/488,296

(22) Filed: Oct. 17, 2023

(51) Int. Cl. B01D 35/153; B01D 29/15; F16J 15/06

(52) U.S. Cl. CPC B01D 35/153; B01D 29/15; F16J 15/06; B01D 2201/167; B01D 2201/304; B01D 2201/4092

(57) ABSTRACT

A filter for a fluid system includes a filter housing, and a filter medium within the filter housing. A filter cap component is coupled to the filter housing and includes a fluid distribution wall having therein a plurality of fluid openings. The filter further includes a seal having an annular central body and a valving skirt contacting an outgoing wall surface of the filter cap component at an anti-drain back sealing location. The valving skirt is deformable away from the outgoing wall surface to permit fluid flow through the fluid distribution wall, and alternately seals against the fluid distribution wall to prevent drain back.

### TECHNICAL FIELD

The present disclosure relates generally to a filter in a fluid system, and more particularly to a seal in a filter functioning as an anti-drain back valve.

### BACKGROUND

Filter systems for a variety of fluids are used in many different industries. With respect to machinery, fluid filters are used in engine oil systems, hydraulic systems, fuel systems, cooling systems, and many others. Filters tend to accumulate debris over time necessitating cleaning, and commonly replacement of a filter element or filter medium. In an effort to facilitate filter replacement and servicing while maintaining optimal filter efficacy, many relatively sophisticated filter designs having multiple parts and made of various different materials are well-known throughout the world.

In many filter systems, it is desirable to convey dirty fluid to be filtered in one direction through the filter while restricting backflow or “drain back” of the fluid in an opposite direction. Many fluid systems are fairly dynamic with regular changes and even reversals of fluid pressure and flow through the system. It is also generally desirable to strictly limit the potential for mixing of dirty fluid with fluid that has already been filtered. Accordingly, various filter systems employ a drain back valve that prevents a reversed flow of fluid into or out of the filter. One known filter design apparently usable in an engine oil system is set forth in U.S. patent application Ser. No. 18/234,970, filed Aug. 17, 2023, to Oedewaldt et al.

### SUMMARY

In one aspect, a filter for a fluid system includes a filter housing, and a filter medium at least partially within the filter housing and including a center tube defining a first fluid passage. The filter further includes a filter cap component coupled to the filter housing and including an outer peripheral surface, and an inner peripheral surface forming a central opening defining a center axis. The filter cap component further includes a fluid distribution wall extending radially outward of the inner peripheral surface and including therein a plurality of fluid openings extending from an incoming wall surface to an outgoing wall surface. A fitting is positioned within the central opening and forms a second fluid passage fluidly connected to the first fluid passage. A seal including an annular central body is positioned within the fitting, and a valving skirt contacts the outgoing wall surface at an anti-drain back sealing location radially outward of the plurality of fluid openings and being deformable away from the outgoing wall surface to permit fluid flow through the plurality of fluid openings.

In another aspect, a filter component assembly includes a component body 45 including an outer peripheral surface, an inner peripheral surface forming a central opening defining a center axis, a fluid distribution wall extending radially outward of the inner peripheral surface, and a side wall having the outer peripheral surface thereon and extending in an axial direction from the fluid distribution wall. The fluid distribution wall includes therein a plurality of fluid openings extending from an incoming wall surface to an outgoing wall surface and defining incoming fluid flow paths in the axial direction. The filter component assembly further includes a seal having an annular central body positioned within the central opening, and a valving skirt contacting the outgoing wall surface at an anti-drain back sealing location radially outward of the plurality of fluid openings and being deformable away from the outgoing wall surface to permit fluid flow through the plurality of fluid openings.

In still another aspect, a seal for a fluid filter includes a one-piece seal body having an annular central body forming a central opening defining a center axis, and a valving skirt. The annular central body includes an axially projecting cylindrical neck portion extending from the valving skirt in a first axial direction to a body end including a circumferential bead projecting in a radially outward direction. The valving skirt extends in the radially outward direction from the annular central body to an outer peripheral edge extending circularly and circumferentially around the center axis, and includes a planar skirt sealing surface facing the first axial direction and extending from the outer peripheral edge to the cylindrical neck portion, and a skirt opposite surface facing a second axial direction. The one-piece seal body is formed uniformly of a non-metallic material, and the valving skirt is deformable relative to the annular central body in the first axial direction from an anti-drain back sealing configuration where the valving skirt extends normal to the center axis, to a fluid admission configuration.

### BRIEF DESCRIPTION OF THE DRAWINGS

FIG. 1 is a diagrammatic view of a machine system, according to one embodiment;

FIG. 2 is a diagrammatic disassembled view of a filter, according to one embodiment:

FIG. 3 is a sectioned side diagrammatic view of a filter for a fluid system, according to one embodiment:

FIG. 4 is a sectioned side diagrammatic view of portion of a filter, according to one embodiment:

FIG. 5 is a diagrammatic view of a filter, in partial cutaway, according to one embodiment; and

FIG. 6 is a sectioned side diagrammatic view of a portion of a filter, according to one embodiment.

### DETAILED DESCRIPTION

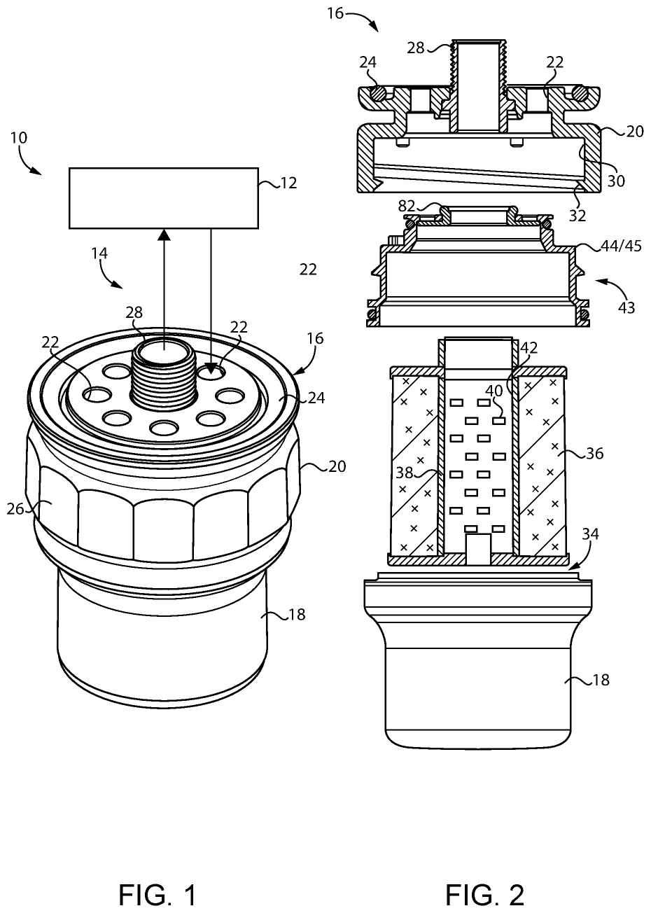

Referring to FIG. 1, there is shown a machine system, according to one embodiment, and including a machine 12 and a fluid system 14. Machine 10 may include an internal combustion engine, such as a compression-ignition diesel engine. In other embodiments, a different machine type or machinery subsystem such as a hydraulic system, a transmission system, or still another is contemplated. Fluid system 14 may include an engine oil system circulating and potentially cooling engine oil and having appropriate conduits, pumps, heat exchangers, et cetera. Fluid system 14 also includes a filter 16 for filtering a working fluid such as engine oil. Filter 16 may include a filter housing or canister 18 and various internal components therein, as well as a shroud 20. Shroud 20 may be attached to machine 12 in some embodiments, and includes a seal 24 for sealing against a housing such as an engine housing or a part thereof.

In an embodiment filter housing 18 and other components can be twisted off from engagement with shroud 20 while shroud 20 remains in place attached to a machine housing. Filter 16 also includes a fitting 28 that can be threaded engaged with a machine housing and rotated to axially compress and engage seal 24. In the illustrated embodiment, a plurality of inlets 22 are formed in shroud 20 and receive an incoming flow of fluid to be filtered. Fitting 28 may convey an outgoing flow of fluid back to machine 12, to a secondary filter, to a cooler, or to a pump to name a few examples. Shroud 20 may include a shroud outer surface 26 configured by way of tool engagement surfaces or surfaces configured to be gripped by a user's hand for enabling insulation in a machine housing.

Referring also now to FIG. 2, there is shown filter 16 disassembled and illustrating additional parts and features thereof. Shroud 20 includes a shroud inner peripheral surface 30 including internal threads 32 thereon. In an alternate embodiment internal threads 32 could be configured as external threads. Filter housing 18 defines a fluid cavity 34 and a filter medium 36 is positionable at least partially within filter housing 18. Filter medium 36 can include any suitable filter medium, and also includes a center tube 38. Filter medium 36 may extend circumferentially around center tube 38 and center tube 38 includes therein a plurality of perforations 40 that enable a flow of filtered fluid to enter a first fluid passage 42 defined by center tube 38. Filter 16 also includes a filter cap component 44 in a filter component assembly 43. Filter cap component 44 includes a component body 45, referred to at times interchangeably with filter cap component 43. Filter cap component 44 (hereinafter filter component 44) may be coupled to filter housing 18.

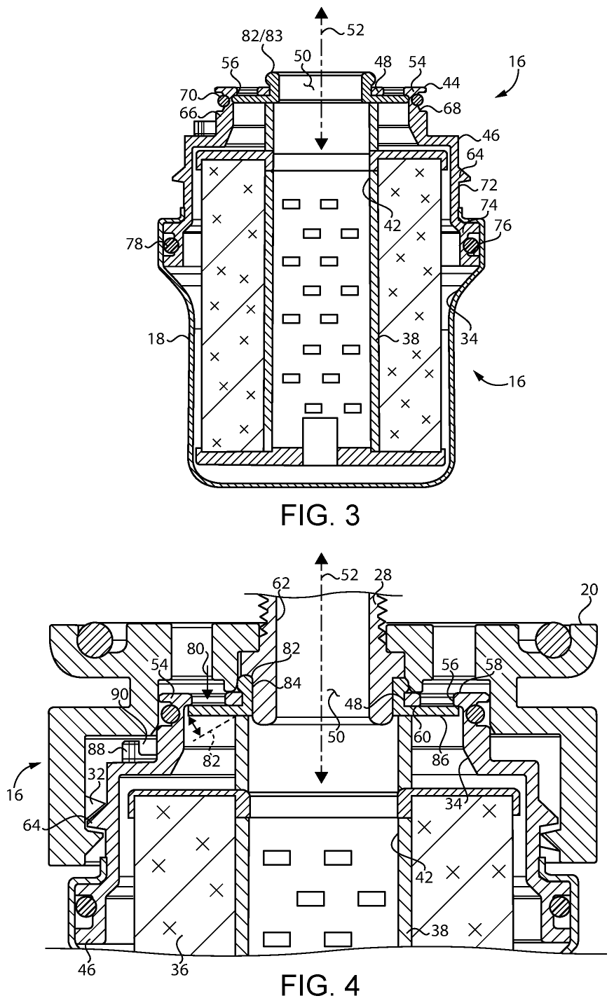

Referring also now to FIGS. 3 and 4, filter component 44 includes an outer peripheral surface 46 having threads 64 thereon. Threads 64 may include external threads structured to mate with internal threads 32 approximately as shown in FIG. 4. In an alternate embodiment, threads 64 could include internal threads. Moreover, while threads 32 and 64 are discussed herein in the plural, a singular thread is also understood to be described by the plural term. In still other embodiments a click-in engagement strategy such as a slot and tab engagement strategy could be used to couple shroud 20 to filter component 44.

Filter component 44 includes an inner peripheral surface 48 forming a central opening 50 defining a center axis 52. Filter component 44 also includes a fluid distribution wall 54 extending radially outward of inner peripheral surface 48 and including therein a plurality of fluid openings 56. Fluid openings 56 may have a regular circumferential distribution around center axis 52 and are spaced radially outward of central opening 50. Fluid openings 56 extend from an incoming wall surface 58 facing a first axial direction in opposition to an incoming flow of fluid to be filtered, or dirty fluid, to an outgoing wall surface 60. Fluid openings 56 define incoming fluid flow paths 80 in a second axial direction. Fitting 28 is positioned within central opening 50 and forms a second fluid passage 62 fluidly connected to first fluid passage 42.

Filter component 44 or component body 45 may also include a sidewall 66 having outer peripheral surface 46 thereon and extending in the second axial direction from fluid distribution wall 54. Sidewall 66 may include a first sidewall and includes a seal groove 68 formed therein within which a seal 70 is seated. With filter component 44 coupled to shroud 20 seal 70 may seal between filter component 44 and shroud 20. Filter component 44 and component body 45 may also include a second sidewall 72 stepped radially outward of first sidewall 66 and including threads 64 thereon. Second sidewall 72 may extend in the second axial direction. Filter component 44 may also include a third sidewall 74 stepped radially outward of second sidewall 72 and including a second seal groove 76 having a seal 78 seated therein. In an embodiment, filter housing 18 may be crimped or otherwise mechanically deformed around third sidewall 78. Other attachment strategies could nevertheless be used. Each of seals 24, 70, and 78 may include a conventional O-ring seal formed of a rubber material such as natural rubber or synthetic rubber, for example.

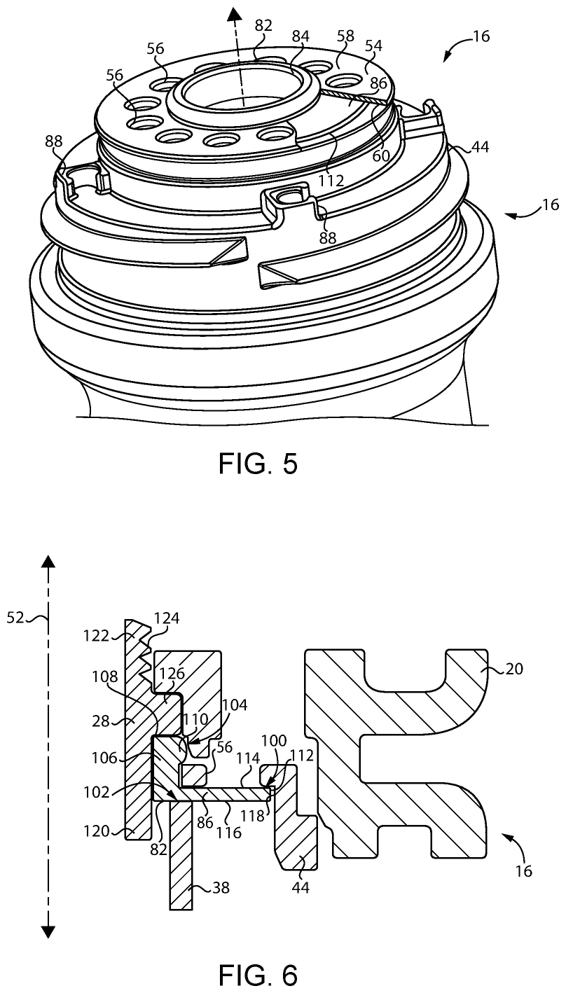

Filter 16 also includes another seal 82 of a different configuration, and as further discussed herein performing multiple sealing functions as well as an anti-drain back function. Referring also now to FIGS. 5 and 6, seal 82 includes a one-piece seal body 83, also referred to at times interchangeably with seal 82. Seal 82 includes an annular central body 84 positioned within central opening 48, and in the illustrated embodiment positioned radially between filter component 44 and fitting 28. As shown in FIG. 6, fitting 28 includes an inlet end 120 positioned within central opening 50 radially inward of annular central body 84, an outlet end 122 including external threads 124, and a flange 126 between inlet end 120 and outlet end 122 and in contact with annular central body 84.

Seal 82 may further include a valving skirt 86 contacting outgoing wall surface 60 at an anti-drain back sealing location 100 radially outward of fluid openings 56. Valving skirt 86 is shown in the drawings in an anti-drain back sealing configuration where valving skirt 86 extends normal to center axis 52. Valving skirt 86 may be deformable away from outgoing wall surface 60 to a fluid admission configuration to permit fluid flow through fluid openings 86. An example fluid admission configuration wherein valving skirt 86 has been deformed is shown in phantom line in FIG. 4. Seal 82 may further contact center tube 38 at a static sealing location 102 that is radially inward of anti-drain back sealing location 100. Seal 82 may further contact shroud 20 at a second static sealing location 104.

It will thus be appreciated that anti-drain back sealing location 100 may be radially outward of fluid openings 56 and extends circumferentially around center axis 52. Static sealing locations 102 and 104 may likewise extend circumferentially around center axis 52. Static sealing location 102 and static sealing location 104 may function to provide dirty-to-clean seals preventing unfiltered fluid that has entered into cavity 34 from mixing with filtered fluid traveling out through first fluid passage 42 and second fluid passage 62. Anti-drain back sealing location 100 prevents drain back of unfiltered fluid, for various purposes including when filter 16 is disassembled from shroud 20 for servicing. When fluid system 14 is operating an incoming flow of unfiltered fluid can cause valving skirt 86 to unseal at anti-drain back sealing location 100 to permit admission of unfiltered fluid into filter 36 for filtering.

Focusing on FIG. 5, there is shown filter 16 where fluid distribution wall 54 is sectioned to illustrate valving skirt 86 extending radially outward of annular central body 84. FIG. 5 also illustrates a plurality of pocketed retention elements 88 upon filter component 44 that can be click-lock engaged with posts or pins 90 of shroud 20 to engage filter component 44 and shroud 20, and released to disengage the respective components. It can be appreciated from FIG. 5 that a radially outward extent of valving skirt 86 extending from annular central body 84 to an outer peripheral edge 112 of valving skirt 86 is greater than an axial extent of annular central body 84.

Focusing on FIG. 6, there it can be seen that a clearance 118 is defined radially between outer peripheral edge 112 and filter component 44 including first sidewall 66. Clearance 118 may be continuous circumferentially around center axis 52. Outer peripheral edge 112 extends circularly and circumferentially around center axis 52. Valving skirt 86 also includes a planar skirt sealing surface 114 facing the first axial direction and extending from outer peripheral edge 112 to an axially projecting cylindrical neck portion 106 of valving skirt 86. Valving skirt 86 also includes a skirt opposite surface 116 facing the second axial direction. Neck portion 106 extends from valving skirt 86 in the first axial direction to a body end 108 including a circumferential bead 110. In the illustrated embodiment circumferential bead 110 projects in a radially outward direction to contact shroud 20 at static sealing location 104.

As discussed above, seal 82 may include a one-piece seal body 83. Seal body 83 may be formed as a unitary part such as by injection molding or some other molding technique. Seal body 83 may also be formed uniformly of a suitable non-metallic material, including a natural rubber, a synthetic rubber, or still others. This configuration differs from certain known sealing elements used in fluid filters and anti-drain back valves where a metallic skeleton, backing or one or more other extra parts are used to provide a desired flexibility and elasticity. In one embodiment, the non-metallic material includes a rubber material having a shore D hardness from 65 to 75. In a refinement, the shore D hardness may be from 68 to 72, and potentially equal to 70 within a conventional measuring tolerance.

### INDUSTRIAL APPLICABILITY

Referring to the drawings generally, as discussed herein filter 16 can be employed in a variety of fluid systems. In service, filter 16 is attached to or otherwise fluidly connected to machine 12 and receives an incoming flow of fluid to be filtered through inlets 22 and thenceforth to fluid openings 56. A pressure of the incoming fluid to be filtered can deform valving skirt 86 to permit entry along fluid flow paths 80 into cavity 34 defined by filter component 44 and filter housing 18 as illustrated. The unfiltered fluid then passes through filter medium 36 and into central tube 38. The filtered fluid is then conveyed out of filter 16 by way of fitting 28.

When pressure changes are experienced in fluid system 14, such as when machine system 10 is turned off, valving skirt 86 can elastically return to its anti-drain back sealing location and keep fluid from leaking out of filter 16. It is contemplated filter 16 might be assembled and sold as a complete unit including components approximately as illustrated in FIG. 2. In other embodiments, shroud 20 may remain attached to a machine and other components of filter 16 sold as a service part that can be swapped out for an existing, used filter 16. In still other instances, filter component assembly 43 including filter component 44 and seal 82 might be assembled and shipped for coupling with filter housing 18 and filter medium 36. Seal 82 might itself also be provided as a replacement part.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A filter for a fluid system comprising:
a filter housing;
a filter medium at least partially within the filter housing and including a center tube defining a first fluid passage;
a filter cap component coupled to the filter housing and including an outer peripheral surface, and an inner peripheral surface forming a central opening defining a center axis, and a fluid distribution wall extending radially outward of the inner peripheral surface and including therein a plurality of fluid openings extending from an incoming wall surface to an outgoing wall surface;
a fitting positioned within the central opening and forming a second fluid passage fluidly connected to the first fluid passage; and
a seal including an annular central body positioned within the fitting, and a valving skirt contacting the outgoing wall surface at an anti-drain back sealing location radially outward of the plurality of fluid openings and being deformable away from the outgoing wall surface to permit fluid flow through the plurality of fluid openings.

2. The filter of claim 1 wherein the seal contacts the center tube at a static sealing location that is radially inward of the anti-drain back sealing location.

3. The filter of claim 2 wherein the outer peripheral surface includes first threads, and further comprising a shroud having an inner peripheral surface including second threads, and wherein the seal contacts the shroud at a second static sealing location.

4. The filter of claim 3 wherein the seal includes a bead upon the annular central body contacting the shroud at the second static sealing location.

5. The filter of claim 4 wherein the annular central body includes a cylindrical projection extending from the valving skirt, and the bead projects radially outward of the annular central body.

6. The filter of claim 1 wherein the valving skirt includes an outer peripheral surface, and a clearance is defined radially between the outer peripheral surface and the filter cap component.

7. The filter of claim 6 wherein the seal is one-piece and formed uniformly of a non-metallic material.

8. The filter of claim 7 wherein the non-metallic material includes a rubber material having a shore D hardness from 65 to 75.

9. A filter component assembly comprising:
a component body including an outer peripheral surface, an inner peripheral surface forming a central opening defining a center axis, a fluid distribution wall extending radially outward of the inner peripheral surface, and a sidewall having the outer peripheral surface thereon and extending in an axial direction from the fluid distribution wall;
the fluid distribution wall including therein a plurality of fluid openings extending from an incoming wall surface to an outgoing wall surface and defining incoming fluid flow paths in the axial direction; and
a seal including an annular central body positioned within the central opening, and a valving skirt contacting the outgoing wall surface at an anti-drain back sealing location radially outward of the plurality of fluid openings and being deformable away from the outgoing wall surface to permit fluid flow through the plurality of fluid openings.

10. The filter component of claim 9 wherein the sidewall includes a seal groove formed therein, and the component body includes a second sidewall stepped radially outward of the sidewall and including threads thereon.

11. The filter component of claim 10 wherein the second sidewall extends in the axial direction and the threads include external threads, and wherein the component body includes a third sidewall stepped radially outward of the second sidewall and including a second seal groove formed therein.

12. The filter component of claim 9 wherein the seal includes a bead upon the annular central body.

13. The filter component of claim 12 wherein the annular central body includes a neck portion extending between the valving skirt and the bead.

14. The filter component of claim 13 wherein the bead projects in a radially outward direction.

15. The filter component of claim 9 wherein the seal is one-piece and formed uniformly of a non-metallic material.

16. The filter component of claim 15 wherein the non-metallic material includes a rubber material having a shore D hardness from 65 to 75.

17. The filter component of claim 9 wherein the valving skirt includes an outer peripheral surface, and a clearance is defined radially between the outer peripheral surface and the sidewall.

18. The filter component of claim 9 further comprising a fitting including an inlet end positioned within the central opening radially inward of the annular central body, an outlet end including external threads, and a flange between the inlet end and the outlet end and in contact with the annular central body.

19. A seal for a fluid filter comprising:
a one-piece seal body including an annular central body forming a central opening defining a center axis and a valving skirt;
the annular central body including an axially projecting cylindrical neck portion extending from the valving skirt in a first axial direction to a body end including a circumferential bead projecting in a radially outward direction;
the valving skirt extending in the radially outward direction from the annular central body to an outer peripheral edge extending circularly and circumferentially around the center axis, and including a planar skirt sealing surface facing the first axial direction and extending from the outer peripheral edge to the cylindrical neck portion, and a skirt opposite surface facing a second axial direction; and
the seal is formed uniformly of a non-metallic material, and the valving skirt being deformable relative to the annular central body in the first axial direction from an anti-drain back sealing configuration where the valving skirt extends normal to the center axis, to a fluid admission configuration.

20. The seal of claim 19 wherein the non-metallic material includes a rubber material having a shore D hardness from 65 to 75.
